(19) United States
(12) Patent Application Publication
(10) Pub. No.: US 2025/0038851 A1
(43) Pub. Date: Jan. 30, 2025

(54) METHOD AND SYSTEM FOR COMBINED WI-FI AND PON SCHEDULING AND ASSIGNMENTS

(71) Applicant: DZS Inc., Plano, TX (US)

(72) Inventor: Kenneth J. Kerpez, Long Valley, NJ (US)

(73) Assignee: DZS Inc., Plano, TX (US)

(21) Appl. No.: 18/781,855

(22) Filed: Jul. 23, 2024

Related U.S. Application Data
(60) Provisional application No. 63/515,323, filed on Jul. 24, 2023.

(51) Int. Cl. H04B 10/27; H04W 84/12

(52) U.S. Cl. CPC H04B 10/27; H04W 84/12

(57) ABSTRACT

A method coordinates Passive Optical Networks (PON) scheduling and assignments with Wi-Fi scheduling and assignments and provides information to PON and Wi-Fi nodes that coordinates PON and Wi-Fi transmission. A method including assigning a plurality of optical network logical ports to a plurality of quality of service levels for a wireless network, disseminating first data to a portion of an optical network, disseminating second data to a portion of the wireless network, and facilitating an exchange of packets between the portion of the optical network and the portion of the wireless network.

### CROSS-REFERENCE TO RELATED APPLICATIONS

This application claims the benefit of U.S. Provisional Patent Application 63/515,323, filed Jul. 24, 2023, the disclosure of which is hereby incorporated by reference in its entirety.

### BACKGROUND

A Passive Optical Network (PON) is a type of fiber optic network that uses passive devices such as splitters to distribute a single signal to multiple endpoints. PONs are increasingly being used to provide broadband last-mile connections. A PON Optical Line Terminal (OLT) in the network connects to PON Optical Network Units (ONUs) at or near customer premises.

A Wi-Fi Access Point (AP) typically connects to a Wide-Area Network (WAN) on an interface and then connects across Wi-Fi to stations (STAs). A STA can also be called a client or a user end-device. Each AP has one or more radios (e.g., at 2.4 GHz and 5 GHz), and each radio has one or more Basic Service Sets (BSS). The BSS connects to one or more STAs across Wi-Fi.

A “node” as used herein is any of an OLT, ONU, AP, or STA.

Wi-Fi has used Carrier Sense Multiple Access/Collision Avoidance (CSMA/CA), which is a method that prevents data collisions by using acknowledgments and backoff mechanisms. This random access, operating in unlicensed spectrum, can often have high delays and low reliability. Mechanisms are emerging in recent Wi-Fi standards to address this including Orthogonal Frequency Division Multiple Access (OFDMA) and restricted target wake time (rTWT).

Applications are emerging that require very low network delay, particularly with the rise of edge computing. These applications include Extended Reality (XR), industry 4.0, autonomous vehicles, traffic control, teleoperations, tactile internet, remote surgery, telepresence, time sensitive networking (TSN), etc.

### SUMMARY

This disclosure coordinates PON scheduling, assignments and configurations with Wi-Fi scheduling, assignments and configurations. This improves performance and reduces latency across these two network segments and can result in deterministic, bounded, data delivery times.

PON and Wi-Fi can have jointly optimized schedules, configurations, and time assignments to lower delay. Although connection of PON and Wi-Fi has been discussed, real coordination has not been considered. Some use of information about Wi-Fi has been considered for PON, but with no coordination.

### BRIEF DESCRIPTION OF THE DRAWINGS

Having thus described the disclosure in general terms, reference will now be made to the accompanying drawings, which are not necessarily drawn to scale, and wherein:

FIG. 1 shows an example network diagram according to some embodiments.

FIG. 2 shows an example priority, channel, and resource assignment flowchart according to some embodiments.

FIG. 3 shows example downstream PON Time-Division Multiple Access (TDMA) and Wi-Fi according to some embodiments.

FIG. 4 shows example upstream PON TDMA and Wi-Fi according to some embodiments.

FIG. 5A shows an example upstream timeline with no alignment between PON and Wi-Fi according to some embodiments.

FIG. 5B shows an example timeline with aligned Wi-Fi and PON timing according to some embodiments.

FIG. 6, shows an example multi-AP time alignment via PON timing according to some embodiments.

FIG. 7 shows an example controller-based implementation according to some embodiments.

FIG. 8 shows an example distributed implementation via messaging according to some embodiments.

### DETAILED DESCRIPTION

The disclosure now will be described more fully hereinafter with reference to the accompanying drawings. This disclosure may, however, be embodied in many different forms and should not be construed as limited to the embodiments set forth herein. Rather, these embodiments are provided so that this disclosure will be thorough and complete, and will fully convey the scope of the disclosure to those skilled in the art. One skilled in the art may be able to use the various embodiments of the disclosure.

This disclosure coordinates Passive Optical Networks (PON) scheduling, assignments, and configurations with Wi-Fi scheduling, assignments, and configurations. This improves performance and can reduce latency across these two network segments and can result in deterministic, bounded, data delivery times. Scheduling and assignments can be jointly optimized across PON and Wi-Fi either via central control or via distributed coordination. These assignments can happen in real-time and adapt to varying traffic volumes and types.

### Alignment of Priorities and Channels.

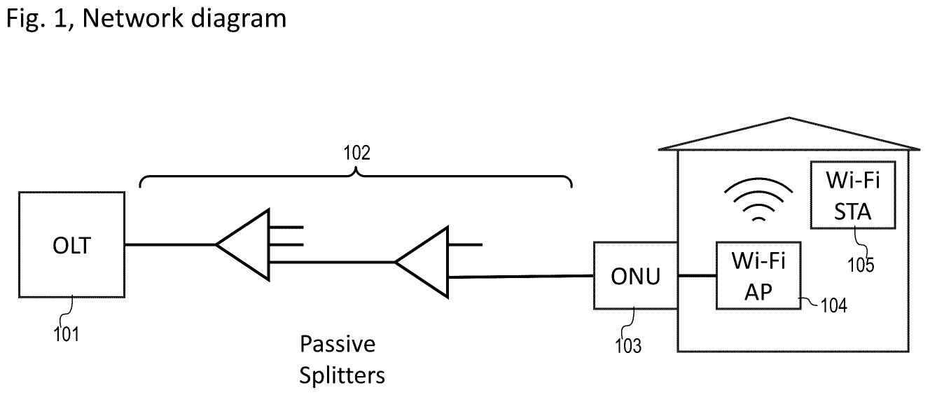

As shown in FIG. 1., PON connections emanate from an OLT 101 and pass through the Optical Distribution Network (ODN) 102, consisting of optical fiber and passive splitters, and then terminate in Optical Network Unit (ONUs) 103. Each OLT port serves multiple ONUs, and these are generally time-shared with time-division multiple access (TDMA). Each ONU then connects across Wi-Fi to one or more Wi-Fi Access Points (AP) 104 to serve stations (STA) 105 in the home. The ONU 103 and AP 104 may be contained in a single box or be separate units. In current practice, there is no coordination between PON and Wi-Fi scheduling, assignments, and configurations so scheduling time-slots or frequencies and other assignments for PON and Wi-Fi links are done separately. Although connection of PON and Wi-Fi has sometimes been discussed, real coordination has not been considered.

ITU-T PON uses the GPON encapsulation method (GEM) to carry data frames over optical fibers. GEM ports are logical ports that identify the data flows for different services or ONUs. Transmission containers (T-conts) are traffic containers that define the upstream bandwidth allocation for each ONU. A given ONU may have several T-conts, each with its own priority or traffic class. One or more GEM ports can be contained within a T-cont. Different traffic classes, flows, or services are assigned to GEM ports and T-conts according to their QoS needs and the traffic demand.

Wi-Fi prioritization and class of service (CoS) or Quality of Service (QOS) are often specified by the eight User Priorities (UP) and the four Access Classes (AC) defined by the Wi-Fi Wireless MultiMedia (WMM) specification (www.wi-fi.org/file/wmm-specification). The different ACs have different contention window timing. In particular, the ACs have different Arbitration Inter-Frame Spacing (AIFS), which is the time a Wi-Fi node must wait before starting the contention window to transmit. The UP can be used to further stratify queue scheduling behavior.

Wi-Fi and PON channelization and priority assignments can be linked. A simple method of PON to Wi-Fi joint traffic assignment is to map PON GEM ports and T-conts directly to Wi-Fi WMM ACs and UPs, and vice-versa. An example of mapping PON to Wi-Fi traffic assignment is shown in Table 1:

TABLE 1

| | IEEE 802.1p | IEEE 802.11 | | |
|---|---|---|---|---|
| | and 802.11 | Access | | GEM |
| | User Priority | Category | | port ID |
| Priority | (UP)) | (AC) | Traffic Type | (example) |
| Lowest | 1 | AC_BK | Background | 10 |
| | 2 | AC_BK | Background | 12 |
| | 0 | AC_BE | Best Effort | 20 |
| | 3 | AC_BE | Excellent Effort | 21 |
| | 4 | AC_VI | Controlled Load | 300 |
| | 5 | AC_VI | Video | 310 |
| | 6 | AC_VO | Voice | 400 |
| Highest | 7 | AC_VO | Network Control | 410 |

Wi-Fi QoS Management (www.wi-fi.org/discover-wi-fi/wi-fi-qos-management) can be used to specify how to assign traffic to WMM ACs and UPs. Wi-Fi QoS Management encompasses: Stream Classification Service (SCS), Mirrored Stream Classification Service (MSCS), Differentiated Service Code Point (DSCP) mapping, and DSCP Policy. Wi-Fi QoS Management can be linked to PON GEM ports/T-conts, for example, by assigning GEM ports as well as Wi-Fi UP to traffic classified by Wi-Fi QoS Management. In SCS signaling, the QosAttrIE can be used by the STA to align its traffic respectively with a specific schedule using parameter service start time (SST) in SCS, and this scheduling can be performed jointly with downstream PON time slot assignments and upstream grants.

After Wi-Fi contention periods, a transmit opportunity (TXOP) is granted to a Wi-Fi AP or STA. The TXOP can be aligned with downstream PON time slot assignments and upstream PON grants

Successive nodes can mark packets with “colors.” Conforming traffic, within the Committed Information Rate (CIR), is marked as green; Exceeding traffic, within the Excess Information Rate (EIR), is marked as yellow; Violating traffic, exceeding both the EIR and CIR, is marked as red. The next node uses this color to drop red traffic before yellow traffic and to drop yellow traffic before green traffic. For example, downstream traffic may be marked by a color at an OLT, then this color can be used to determine how to police or drop traffic at the Wi-Fi AP.

Fiber is typically a very reliable medium with low error rates; however, Wi-Fi can be prone to errors. PON traffic requiring a low error rate can be assigned to the highest reliability Wi-Fi UP, channel, or link. Or, this traffic can be transmitted across Wi-Fi with redundancy, with packet repetition or error coding. End-to-End Application Layer (AL) Forward Error Correction (AL-FEC) can be applied across both PON and Wi-Fi.

PON assignments can be aligned with Wi-Fi band steering, channel assignment, and client steering. PON bandwidth availability and assignment can be matched to that of Wi-Fi. Different bands can support different QoS levels, e.g., 5 GHz typically has more bandwidth than 2.4 GHz, and 6 GHz typically has more bandwidth than 5 GHz. Wider Wi-Fi channels offer higher speeds but sometimes have more collisions and higher delays and so sometimes have increased delays. A STA can be steered to attach to a different AP or BSS. These Wi-Fi assignments can be matched to PON assignments so that they can jointly deliver services with sufficiently high bandwidth and low delay.

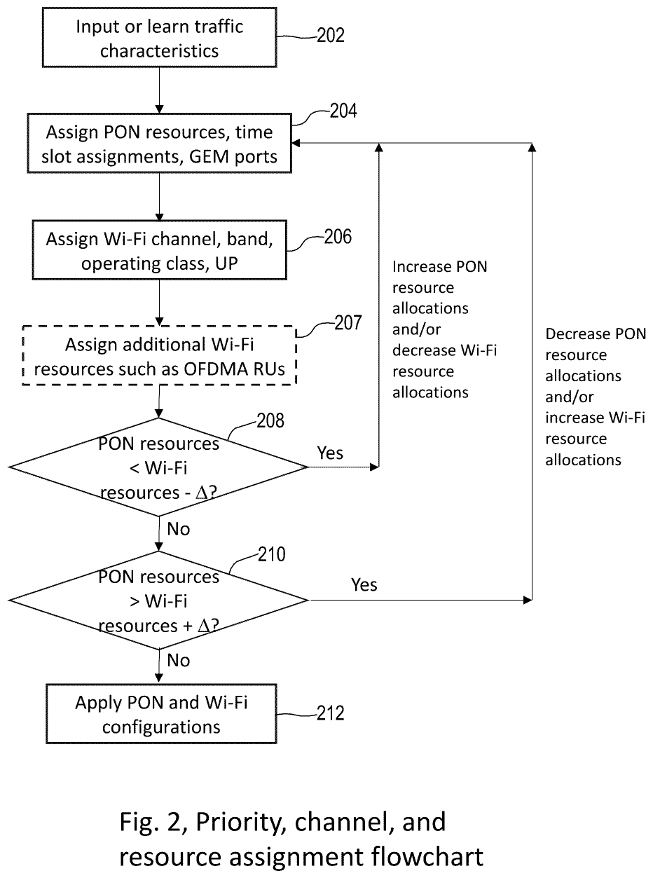

FIG. 2 shows a flowchart for joint PON and Wi-Fi priority, channel, and resource assignment. First, traffic characteristics are input, learned, or otherwise measured at action 202. Traffic characteristics can be input from an external system such as a resource or service assignment system. Traffic measurements can be from queue lengths or offered load. Then, PON resources are determined so that they meet the traffic demand at action 204. These resources can include GEM ports, T-conts, priorities, QoS assignments and time parameters. Then, Wi-Fi resources are determined so to also meet the traffic demand at actions 206-207, possibly including Wi-Fi channel, band, UP, AC, QOS management parameters, Traffic Specification (TSPEC) elements, OFDMS RUs, rTWT times, BSS coloring parameters, and time parameters. If the PON resources are such that the data rate and delay and possibly other QoS attributes exceed those provided by the Wi-Fi significantly (by some delta) at action 208, then PON resource allocation is increased (e.g., by increasing priority or time slot lengths) or Wi-Fi resource allocation is decreased (e.g., by decreasing the channel bandwidth or priority). If at action 210 the Wi-Fi resources are such that the data rate and delay and possibly other QoS attributes exceed those provided by the PON significantly (by some delta), then PON resource allocation is increased or Wi-Fi resource allocation is decreased. The PON and Wi-Fi configurations are applied at action 212.

### Combined Scheduling.

Typically, the frame length for ITU PON is 125 microseconds in both downstream and upstream directions. The scheduling of which frame a given packet is transmitted in, and the location within a frame of the packet, affects downstream delay.

In the upstream, an ONU first reports its queue lengths to the OLT, then the OLT assigns a grant or multiple grants to the ONU. The grant is a message that specifies the time slot(s) when an individual ONU may transmit upstream data. This process results in delay; including time for the report to be sent and received by the OLT, plus time for the OLT to process this and other reports to determine grants, plus time to send the grant from OLT to ONU, plus the time to wait until the grant time to transmit. All of these can be exacerbated by the frame timing since messages need to wait until the next frame to be sent. This is a quantization effect, whereby frame times are rounded up. Wi-Fi timing and PON timing can be aligned to largely eliminate this round-up.

The determination and assignment within the OLT of upstream grants is called Dynamic Bandwidth Allocation (DBA). Typically, PON DBA is based only on the demand as reported by the ONUs. Herein, PON DBA can be performed utilizing input about the status of the queues, timing, and traffic on Wi-Fi. Similarly, Wi-Fi scheduling can use input data from the PON. Input can also be traffic characteristics and times from an external resource management, service management or traffic management system.

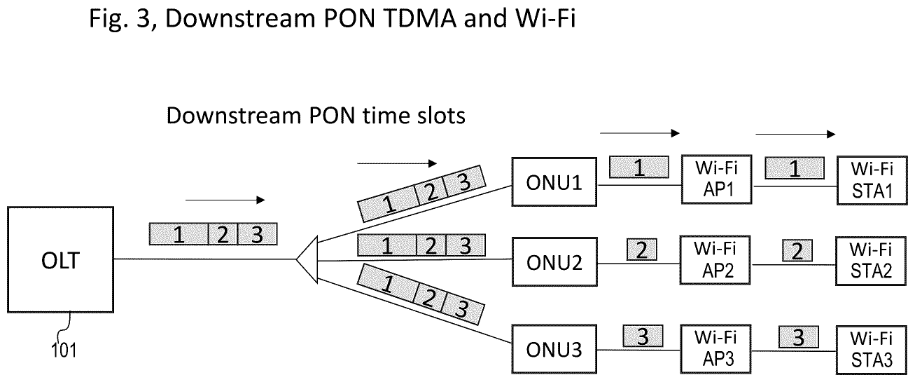

FIG. 3 shows downstream PON and Wi-Fi packet time slots. From the OLT 101, packets 1, 2 and 3 traverse the optical distribution network (ODN) in non-overlapping Time-Division Multiple Access (TDMA) time slots. From there, ONU1 forwards packet 1, ONU2 forwards packet 2, and ONU3 forwards packet 3 to their respective Wi-Fi APs. The APs in turn forward their packets to their respective associated STAs. Each of the OLT, ONU, and AP has to manage queues, sometimes multiple queues with multiple priorities, schedule transmissions out of these queues, and drop some packets when necessary (perform flow control). The management of all these queues can be performed jointly to expedite high priority, or delay sensitive, traffic end-to-end, while allowing longer queue times for low-priority traffic.

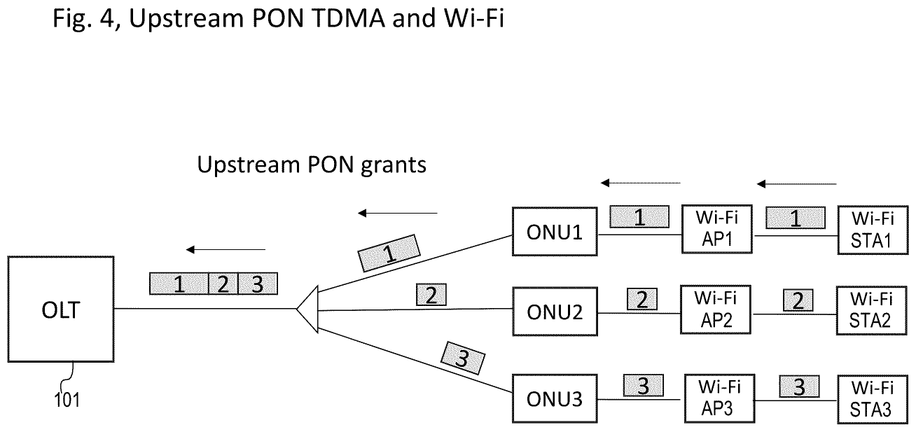

FIG. 4 shows upstream PON and Wi-Fi packet time slots. Each of the Wi-Fi STAs forwards their packets to their associated AP. The APs then forward the packets to their respective ONUs. The ONU waits for the next applicable grant time assigned by the OLT and can then forward their packet to the OLT. Packets 1, 2 and 3 traverse the optical distribution network (ODN) to the OLT at non-overlapping TDMA time slots. Each of the STA, AP, and ONU has to manage queues, sometimes multiple queues with multiple priorities, schedule transmissions out of these queues and drop some packets when necessary (e.g., perform flow control). The management of all these queues and the upstream grant times can be performed jointly to expedite high priority traffic end-to-end, or delay sensitive traffic, while allowing longer queue times for low-priority traffic.

Joint queue management can be important. For example, if the queue length of a downstream packet of a traffic class is so long in the Wi-Fi queues that it will be dropped, then this packet can be dropped within the PON queue, avoiding a wasted transmission hop across Wi-Fi. Upstream is similar, whereby the Wi-Fi AP can drop packets that would have been dropped later on the PON anyway. This helps avoid bufferbloat.

High-priority traffic can be treated by expediting its scheduling jointly across PON and Wi-Fi. Time-sensitive traffic can be sent with high priority by assigning it to GEM ports, T-conts, and priorities on the PON and using a corresponding assignment of UP, AC, and QoS management assignments on Wi-Fi.

Wi-Fi frame bursts allow long transmissions from a particular station or AP. Frame bursts can be aligned with PON grants and downstream timing to fit a Wi-Fi frame burst within a PON frame or within adjacent PON frames. A Wi-Fi frame burst is contained within an aggregated PPDU (A-PPDU). Preemption can be performed within A-PPDU, where a newly arriving higher priority packet is inserted into the A-PPDU. Wi-Fi frame bursts can be scheduled to have lengths equal to PON time slots or grants.

RTS/CTS is a mechanism used by Wi-Fi to reduce frame collisions. It involves an AP or STA sending a request to send (RTS) frame before transmitting data and waiting for a clear to send (CTS) frame from the receiver. After CTS, no other nodes can use the channel for some time. An AP can send an RTS at a time at or a little before a PON time slot assignment with traffic for that AP, so that the Wi-Fi channel is available when the PON traffic arrives for that AP. Similarly, a STA can send an RTS that aligns with an upstream PON grant.

Scheduling selects amongst queues and can re-order queues. Flow-control (aka policing or shaping) drops packets as needed. A classifier defines a set of filters to classify traffic and the action associated with each filter. A policy is a set of classifiers that are applied as a group. Scheduling can be performed in a hierarchy with multiple levels of cascaded queues. All of these scheduling techniques can be aligned between both Wi-Fi and PON.

Restricted Target Wake Times (rTWT).

A feature of Wi-Fi 7 (IEEE 802.11be) is restricted target wake time (rTWT), which allows an access point (AP) to provide enhanced medium access protection and resource reservation for latency sensitive traffic. Traffic can be assigned to a specific schedule using the Target Wake Times (TWT).

rTWT restricts channel access to only the STA(s) of interest in a specific series of time-slots or transit opportunity (TXOP). This can guarantee a specific set of time-slots for the STA. STAs can negotiate participation within rTWT service periods scheduled by the AP, which broadcasts the rTWT schedule for the BSS. The rTWT can be operated in trigger-mode where the AP is responsible for triggering the member STAs.

Either the STA or the AP assigns wake times. The AP can assign a TWT schedule and virtually reserve the time-slots for exclusive use by particular STAs. rTWT parameters that can be set include the broadcast TWT recommendation and the restricted TWT identifier. A Quiet Element (QE) needs to be advertised by the AP in each beacon instructing all STAs listening to the beacon to NOT transmit during a specific upcoming time slot. QEs can be issued at the rate of the beacon interval (usually 100 ms), and so can be updated to match variations in traffic demand.

Wi-Fi rTWT wake times can be aligned with PON time-slot assignments. rTWT triggers can be set by PON frame arrivals Time-sensitive traffic can be sent with high priority by assigning it to GEM ports, T-conts, and priorities on the PON and using a corresponding assignment of rTWT times on Wi-Fi. This can result in deterministic delay times. rTWT times can be aligned with the corresponding PON frames.

### Coordinated Time Scheduling.

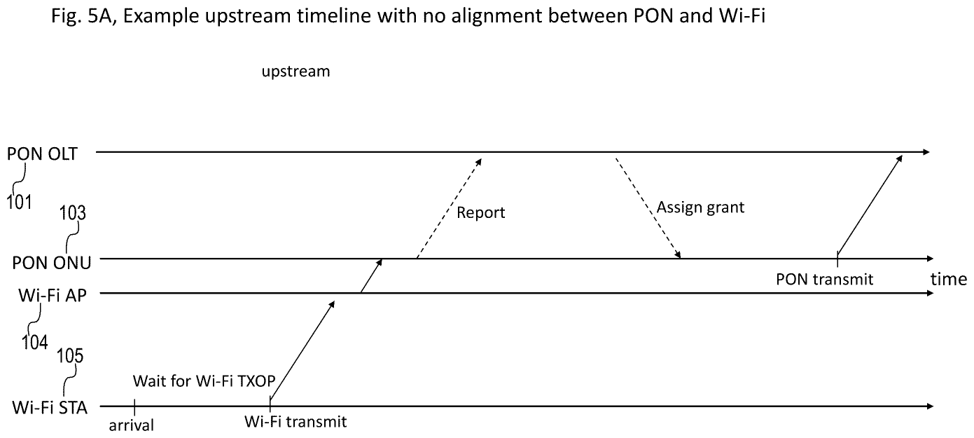

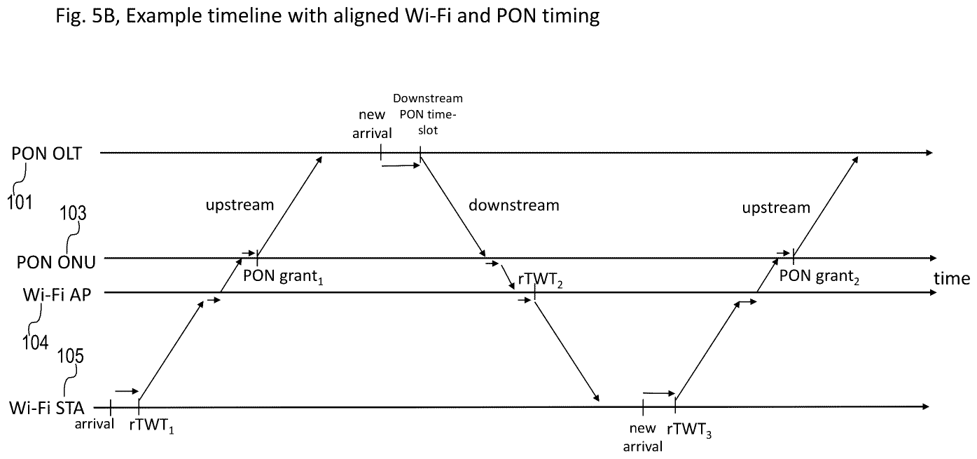

FIG. 5A shows a timeline of an upstream packet transmitted across Wi-Fi and PON with no coordination. The packet arrives from an application at the Wi-Fi STA 105, then must wait for a transmit opportunity (TXOP) to then be sent upstream across the Wi-Fi. Delay between the Wi-Fi AP 104 and ONU 103 is assumed to be minimal. The Wi-Fi AP 104 and ONU 103 can be in the same box or connected over a high-speed underutilized short link. Then the packet arrives at the ONU 103, which then reports the now-occupied queue to the OLT 101. The OLT 101 then assigns a grant time slot to the ONU 103. Finally, the ONU 103 transmits the packet upstream at the grant time. The arrows are slanted due to propagation time. Uncoordinated PON and Wi-Fi priority and channel assignments can decrease these delays somewhat, but they are still significant.

FIG. 5B. shows an example timeline with coordinated of PON and Wi-Fi timing. Here, the PON and Wi-Fi systems and/or a controller have information on each other's timing. A controller can instruct the PON system when to allocate upstream grants and their duration and downstream time slots and instruct the Wi-Fi system when to allocate rTWT times or similar transmit opportunities. Or, traffic arrival and timing information can be exchanged between the PON and Wi-Fi devices which then allocate their transmission times. Wi-Fi may also specify frame burst duration or the duration of transmission, and use of RTS/CTS.

The system can determine joint Wi-Fi and PON timing knowing packet transmission time durations across Wi-Fi and PON and internal time durations for each node to handle the packet, such that scheduling can be performed to ensure minimal delay as the packet traverses both the Wi-Fi and PON media and all the nodes. Each node has a small internal time duration from a packet's reception until its transmission, to ensure enough time to account for buffering, serialization, and internal processing delay. Here it is assumed that the transmission time duration between the ONU 103 and Wi-Fi AP 104 is very small, although this can be accounted for if it is larger.

The system can send probing packets, receive data from an external system, perform offline estimation, or track each of the time durations over time, and then estimate the time durations assuming the system is minimizing delay, e.g., there is no extra queueing time. The system estimates or calculates the maximum of these time durations and uses these maxima to ensure that there is sufficient time. The Table below shows an example of these time durations. Note that there is no framing delay here since the packet is assumed to be anticipated and so can be inserted in a frame as soon as it arrives; if there is framing delay, then this delay can also be accounted for.

Requirements for specific delays needed for specific services or flows can be input from external systems such as services management or resource management, the network, application, or end device. This input can further inform the joint PON and Wi-Fi scheduling.

Table 2 lists example time durations. Times are the maximum assuming the system is minimizing delay.

TABLE 2

| | microseconds |
|---|---|
| Upstream | |
| Time from packet arrival at STA until | 30 |
| transmission | |
| Wi-Fi packet transmission time | 50 |
| Time from packet arrival at AP until transmission | 25 |
| Transmission time from AP to ONU | 10 |
| Time from packet arrival at ONU until | 30 |
| transmission | |
| PON packet transmission time to OLT | 40 |
| Total upstream | 185 |
| Downstream | |
| Time from packet arrival at OLT until | 25 |
| transmission | |
| PON packet transmission time to ONU | 30 |
| Time from packet arrival at ONU until | 30 |
| transmission | |
| Transmission time from ONU to AP | 10 |
| Time from packet arrival at AP until transmission | 25 |
| Wi-Fi packet transmission time | 50 |
| Total downstream | 170 |

In Table 2 above, in the upstream direction, Wi-Fi transmission is scheduled at 30 microseconds after the initial packet arrival, and then the upstream PON grant is scheduled at 145 microseconds after the initial packet arrival (the sum of all time up to and including Time from packet arrival at ONU until transmission). Initial packet arrival times may be known ahead of time (e.g., for periodic arrivals), predicted by a prediction algorithm, messaged from an external system, or the arrival time may be messaged across the system as the packets arrive and this may invoke triggered rTWT.

In Table 2 above, in the downstream direction, PON transmission is scheduled at 25 microseconds after the initial packet arrival, and then the Wi-Fi transmission is scheduled at 120 microseconds after the initial packet arrival (the sum of all time up to and including Time from packet arrival at AP until transmission).

Some small additional time durations may be added to this schedule to ensure sufficient time.

PON scheduling data can be exchanged using techniques for virtual Dynamic Bandwidth Allocation (vDBA) as in Broadband Forum TR-402 and TR-403 and ITU-T G.Sup71.

An implementation of this scheduling with time durations is shown in FIG. 5B. Each arrow in FIG. 5B is a time duration that can be accounted for. The first step of FIG. 5B is a packet arrival, then the packet is transmitted across the Wi-Fi uplink at rTWT time rTWT1. After the first step, the upstream packet goes to the AP 104, is received in just enough time so that it can then be sent upstream on the PON at time PON grant1 and is then sent across the PON ODN and received by the OLT 101. Independently, a packet arrives at the OLT 101 and is then transmitted in a downstream PON time-slot across the PON ODN. The downstream packet is received by the PON ONU 103 and forwarded to the Wi-Fi AP 104 in just enough time so that it can then be sent downstream on Wi-Fi at time rTWT2, and is then sent across Wi-Fi and received by the Wi-Fi STA 105. An additional upstream packet is further shown. Note that upstream and downstream times can overlap, and there may be multiple time-division channels with this process running concurrently on each.

With coordinated scheduling as shown in FIG. 5B delay can be half or less that of uncoordinated scheduling shown in FIG. 5A.

### Wi-Fi BSS Coloring.

BSS coloring is a feature of Wi-Fi 6 (IEEE 802.11ax) that helps reduce interference and improve performance in high-density networks. BSS coloring avoids interference by defining groups of BSS, their reception thresholds, and their transmit powers. It assigns a different “color” (a 6-bit code) to each group of BSSs and allows devices to ignore signals from different BSSs based on their colors. Detection thresholds are the received signal power values that determine whether a device should defer or transmit on a shared channel. A transmitter will defer transmission if it receives signal power higher than the Clear Channel Assessment (CCA) threshold. A co-channel BSS that can be heard at an RSSI greater than the CCA threshold is called an overlapping BSS (OBSS). Signals with the same BSS color use a low threshold to avoid collisions within the same BSS, while signals with different BSS colors use a higher threshold to allow more simultaneous transmissions across different BSSs. The CCA threshold can be set to different levels for BSS within the same color and for BSS with different colors. Transmit powers can be similarly adjusted. The transmit powers and CCA thresholds can be further adjusted according to the interference level. BSS coloring, CCA thresholds and transmit powers can be optimized to align with PON assignments and usage.

### Wi-Fi Multi-Link Operation (MLO).

Multi-Link Operation (MLO) is a new feature of Wi-Fi 7. A Multi-Link Device (MLD) supports MLO. There are different levels of MLO, from a single MLD radio using time-slicing to listen on and use uncongested channels, to multiple entirely separate MLD radios supporting simultaneous transmit and receive on multiple affiliated links. MLO provides redundancy that can support reliability, sending some packets across faster links for low delay, and supporting low error rate using redundancy across the links.

MLO scheduling can be combined with PON scheduling. Traffic on a PON GEM port or T-conts that need low delay can be sent across the least congested MLD affiliated link. High bandwidth PON traffic can be assigned to flow across multiple MLO affiliated links. Traffic requiring low latency can be sent across the affiliated link with least delay. Similar routing can apply to other QoS attributes such as error rates.

Optical media is typically reliable while wireless is not. PON traffic requiring reliability or low error rates can be replicated across multiple links using simple packet repetitions, with the same packet sent across multiple links. Or, error correction coding can be applied to provide redundancy across the links. Hybrid ARQ (HARQ) can be applied across multiple links. Advanced coordinated coding (see reference [3]) can also be applied across multiple links. The Wi-Fi MLO redundancy can be matched, as close as possible, to the supported PON error rates and reliability.

Wi-Fi MLO can be coordinated with multiple WAN connections, multiple PON wavelength connections, multiple optical carriers, or other redundant connections. For example, the high-speed MLO affiliated link can connect to the high-speed WAN connection, or the low delay MLO affiliated link can connect to the low-delay WAN connection.

### Frequency Alignment.

Orthogonal Frequency Division Multiple Access (OFDMA) was added to Wi-Fi 6 (IEEE 802.11ax). OFDMA allows deterministic scheduling and allows multiple clients to transmit or receive from an Access Point at the same time by sharing available bandwidth. OFDMA improves wireless network performance and efficiency by allowing the assignment of sets of independently modulated subcarriers to be assigned to different stations or applications. OFDMA subcarrier sets are called resource units (RUs).

Data fitting within an assigned PON time slot can be carried by a corresponding Wi-Fi OFDMA RU or set of RUs. Repetitive or predictable traffic can be assigned to a repetitive set of RUs and PON time slots, for example, constant bit rate traffic can be assigned to reserved periodic PON time slots and Wi-Fi RUs with minimal delay between the two.

Some PON systems may carry traffic using a type of frequency division multiplexing (FDM) using multiple subcarriers or multiple wavelengths. Subcarriers can be modulated on in-phase (I) and quadrature (Q) components of a carrier and detected with a coherent detector. Wi-Fi OFDMA RUs can be aligned with PON subcarriers, such that certain PON subcarriers, frequencies or wavelengths are mapped directly into Wi-Fi OFDMA RUs, and vice-versa. This direct frequency mapping can provide very low delay. PON subcarriers and their mapping to Wi-Fi OFDM RUs can be allocated ahead of time to support constant bit rate or predictable traffic. An external system can provide information on the bandwidth needed to provide a service, so that then the bandwidth is assigned both on PON subcarriers and Wi-Fi OFDMA RUs at service start.

Multi-wavelength PON and wavelength division multiplexed (WDM) can have wavelengths similarly mapped to Wi-Fi OFDMA RUs. PON subcarriers can also be time-division multiplexed as well as FDM, and future Wi-Fi OFDMA may also use time division; in these cases, both the frequency and the time slot allocations can be matched between PON and Wi-Fi.

### Wi-Fi 8 and Time Coordination.

Wi-Fi 8 (IEEE 802.11bn) is the next generation of Wi-Fi technology and is aimed at Ultra High Reliability (UHR). One of the aspects that will impact reliability is determinism, which means providing service availability and delay guarantees. Wi-Fi 8 will pursue determinism through coordination and other mechanisms. Wi-Fi 8 should also address overlapping BSS. Wi-Fi 8 Multiple Access Point (AP) coordination may allow multiple APs to coordinate their transmissions and avoid overlapping transmissions (in time and frequency) to avoid interference, improving spectrum efficiency and performance.

Wi-Fi 8 coordination mechanisms such as AP coordination and coordinated TDMA can be used to align PON time slot assignment with Wi-Fi transmission opportunities (TXOPs) and other Wi-Fi timing such as rTWTs. This can minimize the delay between when a packet is received by a PON ONU and then transmitted by a Wi-Fi AP, and vice-versa. Upstream PON grant times can be aligned with Wi-Fi uplink transmit times. Downstream PON time slot assignment can be aligned with Wi-Fi downlink transmit times. Timing may be calculated similar to the example as described for FIG. 5B.

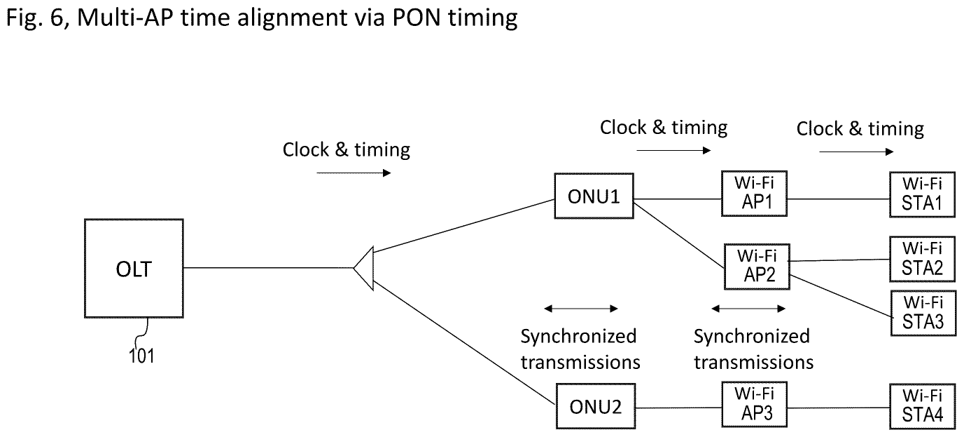

FIG. 6 shows multi-AP time coordination via PON timing. Here, clock and time information is distributed from the OLT 101 down to the ONUs, Wi-Fi APs, and optionally also to the Wi-Fi STAs. Timing could alternately be sourced from any other capable network node. Transmission times are assumed to be controlled across the Wi-Fi network by Wi-Fi 8 AP coordination or other mechanisms. With this set-up, Wi-Fi transmission times can be scheduled as well as the PON transmissions (which are always scheduled), and these Wi-Fi and PON schedules can be aligned together. Downstream PON time-slot scheduling and upstream PON grant times are also controlled and are coordinated with the Wi-Fi transmission times. Timing for each Wi-Fi association may be calculated similar to the example as described for FIG. 5B.

In the case of FIG. 6, there can be multiple Wi-Fi APs and ONUs, and so these can all be controlled. Joint optimization of multiple APs across multiple ONUs and multiple premises can be performed across all the PON and Wi-Fi connections. Data on traffic characteristics, traffic arrivals, channel and buffer states can be input to this optimization.

Multiple MLDs using MLO can be further coordinated by Wi-Fi 8 AP coordination or other mechanism across the multiple ONUs and premises. Millimeter wave transmission can be used on some MLO link(s).

A central controller can assign Wi-Fi 8 time slots as well as assigning PON time slots. This can be done via virtual DBA (vDBA) mechanisms as in Broadband Forum TR-402 and TR-403 and ITU-T G.Sup71.

PON and Wi-Fi symbol times can further be synchronized to a common clock. This can be used to synchronize PON and Wi-Fi time, frequency, and phase.

Other Wi-Fi 8 techniques may include coordinated beamforming, coordinated multi-point (CoMP), and coordinated OFDMA. These can be aligned with PON transmission, in particular coordinated OFDMA can further be coordinated to match PON bandwidth, subcarrier, and wavelength assignments.

### Controller and Distributed Messaging.

The methods described herein may be implemented in different ways, and two implementations are described there: implementation that is controller-based and implementation using distributed messaging.

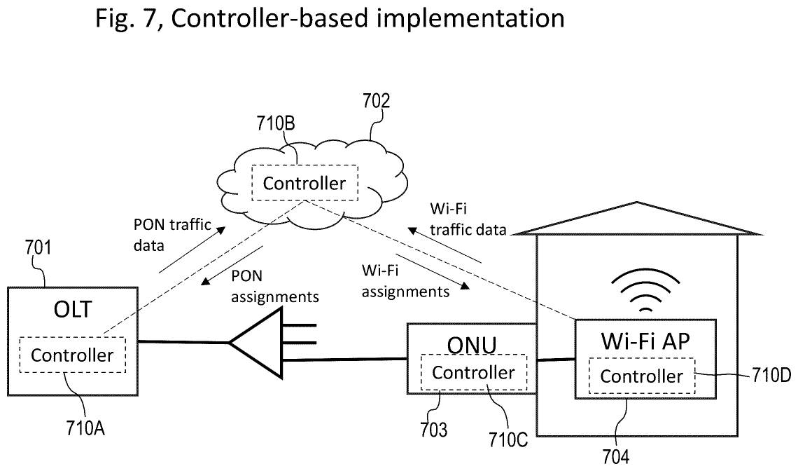

FIG. 7. Shows a controller-based implementation. The controller 710 inputs PON traffic data from the PON OLT 701 and possibly also from the PON ONU 703. The controller 710 also inputs Wi-Fi traffic data from the Wi-Fi AP(s) 704 and possibly also from Wi-Fi STAs (not shown). Traffic data may consist of characteristics of services, flows, streams or packets. Characteristics can include data rate, offered load, bit rate and delay and error rate requirements, arrival times, transmission times, delay durations, internal delays, priorities and priority mappings, queue lengths, capabilities, configuration settings, data on the transmission environment, performance data, diagnostics, fault data, status data, and other data. The controller 710 issues assignments to both PON and Wi-Fi. Assignments may include transmission times, time slots, grant times, rTWT times, priorities, priority mappings, scheduling and policing and flow control configuration, frequency assignments, optical subcarriers or wavelengths, OFDMA RUs, power savings configurations, and other configuration settings.

The controller 710 system may be located in the OLT 701, ONU 703, AP 704, or in a separate computing system such as a cloud 702. The controller 710 may also control multiple ONUs, and at multiple premises.

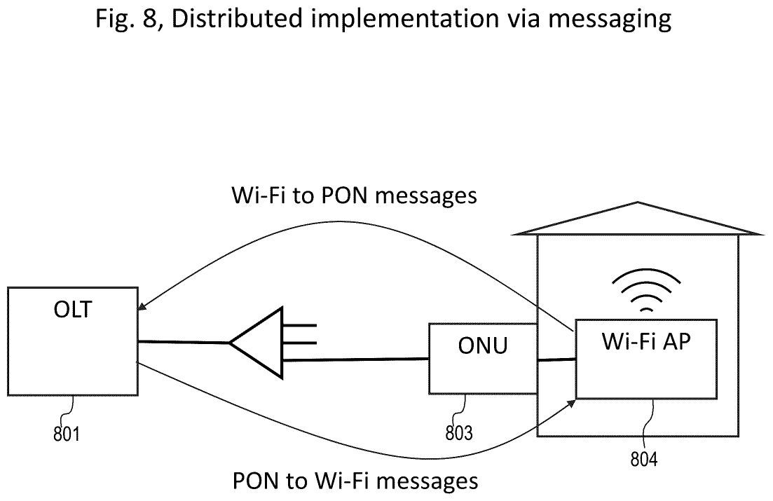

FIG. 8 shows an implementation using distributed messaging. Here the PON OLT 801 and possibly also the PON ONU 803 sends data and configurations to the Wi-Fi AP(s) 804 and possibly also Wi-Fi STAs (not shown). Here also the Wi-Fi AP(s) 804 and possibly also Wi-Fi STAs send data and assignments to the PON OLT 801 and possibly also the PON ONU 803. Multiple ONUs may also be involved. The PON and Wi-Fi systems then use the data to calculate assignments, and these assignments can further be sent to and from PON and Wi-Fi systems.

### Additional Considerations.

PON functions can be virtualized. In particular, OLT functions and OMCI messages can be performed by a virtual OLT (VOLT). All functions described here for a physical OLT (POLT) can similarly be performed by a VOLT.

Joint Wi-Fi and PON scheduling can be combined with power saving modes. Targeted wake time for PON unifying sleep and doze modes can be aligned with Wi-Fi targeted wake times for power savings, and these sleep timings may further be coordinated with traffic scheduling. Further scheduling may provide improvements in energy efficiency for both PON and Wi-Fi.

The techniques disclosed herein can be to applied other wireless systems in addition to Wi-Fi, including HaLow, LoRaWAN, Zigbee, Thread, Zwave, Bluetooth, cellular 4G, 5G and 6G; as well as powerline communication and coaxial-cable. The techniques herein can also be applied with other WAN technologies in addition to PON, including point-to-point optical, active Ethernet, xDSL, G.fast, fixed wireless access (FWA), powerline communication, DOCSIS, cellular 4G, 5G and 6G.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

What is claimed is:

1. A method comprising:
assigning a plurality of optical network logical ports to a plurality of quality of service levels for a wireless network, thereby generating a mapping of the optical network logical ports to the plurality of quality of service levels;
disseminating first data to a portion of an optical network, the first data defining at least a first portion of the mapping;
disseminating second data to a portion of the wireless network, the second data defining at least a second portion of the mapping; and
facilitating an exchange of packets between the portion of the optical network and the portion of the wireless network, including transmitting a first set of the packets from the optical network to the wireless network according to the mapping.

2. The method of claim 1, wherein disseminating the first data comprises:
causing the portion of the optical network to apply settings according to the first portion of the mapping.

3. The method of claim 1, wherein disseminating the second data comprises:
causing the portion of the wireless network to apply settings according to the second portion of the mapping.

4. The method of claim 1, wherein facilitating the exchange of packets comprises:
classifying the packets according to a stream classification service;
aligning a timing of the packets with a parameter service start time in the wireless network; and
coordinating the timing of the packets with downstream optical network timeslot assignments and upstream optical network grants.

5. The method of claim 1, wherein facilitating the exchange of packets comprises:
aligning a plurality of transmit opportunities, granted by the wireless network, with downstream optical network timeslot assignments and upstream optical network grants.

6. The method of claim 1, wherein facilitating the exchange of packets comprises:
aligning a plurality of wake-up times, determined by the wireless network, with upstream grants of the optical network and downstream timeslots of the optical network.

7. The method of claim 1, wherein disseminating the first data to the portion of the optical network comprises issuing, from a controller, priority mappings and transmission timing to the portion of the optical network.

8. The method of claim 7, wherein the controller is located within the wireless network.

9. The method of claim 7, wherein the controller is located outside of the optical networking and outside of the wireless network.

10. The method of claim 7, wherein the controller is distributed between the optical network and the wireless network.

11. The method of claim 1, wherein the optical network comprises a passive optical network (PON), and wherein the wireless network comprises a Wi-Fi network.

12. The method of claim 1, wherein the optical network logical ports comprise GPON encapsulation method (GEM) ports.

13. The method of claim 1, wherein the quality of service levels for the wireless network comprise either or both of User Priorities (UPs) and Access Classes (ACs).

14. The method of claim 1, wherein disseminating the first data to the portion of the optical network comprises transmitting timing assignments from the wireless network to the optical network.

15. The method of claim 1, wherein disseminating the second data to the portion of the wireless network comprises transmitting timing assignments from the optical network to the wireless network.

16. A passive optical network (PON) optical line terminal (OLT) comprising:
at least one processor; and
a transceiver, configured to be controlled by the processor;
wherein the at least one processor is configured to execute computer-readable instructions from a non-transitory computer readable medium to cause the at least one processor to:
map a plurality of optical network logical ports to a plurality of quality of service levels for a wireless network, thereby generating a mapping of the optical network logical ports to the plurality of quality of service levels; and
coordinate packet timing of an optical network, including the OLT, with packet timing of the wireless network for a stream of packets according to the mapping, including transmitting packet timing data from the OLT via the transceiver to a component of the wireless network.

17. The OLT of claim 16, wherein the OLT is communicatively coupled over the optical network to an optical network unit (ONU), wherein the ONU is communicatively coupled to the component of the wireless network.

18. The OLT of claim 17, wherein the computer-readable instructions to cause the at least one processor to transmit the packet timing data to the component of the wireless network includes computer-readable instructions to cause the at least one processor to:
transmit the packet timing data via the ONU.

19. The OLT of claim 16, wherein the at least one processor is further configured to:
receive further packet timing data from the component of the wireless network via the transceiver.

20. A controller, configured to communicate with an optical network and a wireless network, wherein the controller is configured to:
assign a plurality of optical network logical ports to a plurality of quality of service levels for the wireless network, thereby generating a mapping of the optical network logical ports to the plurality of quality of service levels;
disseminate first data to a portion of the optical network, the first data defining at least a first portion of the mapping;
disseminate second data to a portion of the wireless network, the second data defining at least a second portion of the mapping; and
facilitate an exchange of packets between the portion of the optical network and the portion of the wireless network, including transmitting a first set of the packets from the optical network to the wireless network according to the mapping.
